(19) United States
(12) Patent Application Publication
(10) Pub. No.: US 2002/0103093 A1
(43) Pub. Date: Aug. 1, 2002

(54) Method and composition for cleaning a turbine engine component

(76) Inventors: John Robert LaGraff, Niskayuna, NY (US); D. Sangeeta, Cincinnati, OH (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/729,324

(22) Filed: Dec. 5, 2000

(51) Int. Cl. B08B 3/08; B08B 3/12; F02B 77/04

(52) U.S. Cl. 510/185; 134/1; 134/41; 134/34; 134/28

(57) ABSTRACT

In a method for cleaning an engine component, an engine component is provided and is immersed in an acid solution selected from phosphoric acid, citric acid and acetic acid. A cleaning composition for an engine component comprises an agitated acid solution selected from phosphoric acid, citric acid and acetic acid.

### BACKGROUND OF THE INVENTION

The present invention relates to a method and composition for cleaning a turbine engine component.

A typical gas turbine engine includes a compressor, a combustor and a turbine. Compressed gases emerging from the compressor are mixed with fuel and burned in the combustor. Hot products of the combustion emerge from the combustor at high pressure and enter the turbine where thrust is produced to propel the engine and to drive the turbine, which in turn drives the compressor.

The compressor and the turbine include alternating rows of rotating and stationary coated airfoils. High temperature combustion gases degrade the coatings through hot corrosion or oxidation. Gases that circulate through the airfoils, particularly during operation on the ground, also include contaminants such as dirt that has been ingested by the engine. Dirt accumulation can cause serious damage at high engine operating temperatures. Accumulation of dirt can impede effective cooling and if melted, can infiltrate and destroy protective coatings.

The dirt typically comprises mixtures of Ca, Mg, Al, Si, Ni and Fe carbonates and oxides such as multi-elemental spinels (AB₂O₄). A low melting point eutectic Ca₃Mg₄Al₂Si₉O₃₀, (CMAS) similar in composition to diopside, can form from silicate-containing dirts at engine temperatures near 1200° C. and can wet and infiltrate coatings leading to crack formation and component failure.

Other turbine engine component contaminants include thermally grown oxides (TGOs). High temperature engine operation can result in TGO on coatings, which can unintentionally protect an underlying metal coating during chemical stripping. For example alumina scales, which form on metallic MCrAIY coatings impede chemical attack during stripping, thus leading to incomplete coating removal or excessive base metal attack, which can necessitate rework or cause component destruction.

A turbine engine component can be periodically cleaned to remove dirt or the component can be periodically removed from service for repair, which requires a series of cleaning and stripping steps. These steps should remove deposited dirt and strip coating material without adversely attacking the component base metal alloy. Grit blasting is a common method to clean dirt and remove coatings. Unfortunately, grit blasting does not clean dirty or blocked internal passageways. Grit blasting can damage the base alloy thereby thinning airfoil walls. Also, grit blasting may lodge particulates in cracks, where they can impede welding and brazing or in the surface where they can become incorporated into new coatings creating structurally weak regions.

Chemical solutions have been used for cleaning dirt and stripping coatings from gas turbine components. However, these chemical solutions are typically composed of combinations of strong fuming mineral acids or caustic bases. The solutions are often required to include precise amounts of additives such as oxidizers or surfactants. These solutions can require a dedicated (and expensive) chemical facility, including complicated and expensive chemical lines with vents, scrubbers and complex process monitoring equipment.

There is a need for an effective cleaning solution that is environmentally compatible, low cost and that does not attack engine component base metal alloy.

### BRIEF SUMMARY OF THE INVENTION

The cleaning compositions of this invention meet this need. In one embodiment, the invention is a method for cleaning an engine component. In the method, an engine component is provided and is immersed in an acid solution selected from phosphoric acid, citric acid and acetic acid. In another embodiment, the invention is a cleaning composition for an engine component, comprising an agitated acid solution selected from phosphoric acid, citric acid and acetic acid.

### BRIEF DESCRIPTION OF THE DRAWINGS

FIGS. 1, 2 and 3 are schematic cross-sections of a turbine component;

FIG. 4 is a schematic representation of a method for cleaning a turbine component;

FIG. 5 is a graph showing time dependence of percent weight loss of dirt at 50° C.;

FIGS. 6 and 7 are main effects plots;

FIGS. 8, 9, 10 and 11 are optical micrographs of cross-sections of cooling holes; and

FIGS. 12 and 13 are graphs of rate of CMAS coating loss.

### DETAILED DESCRIPTION OF THE INVENTION

The invention provides three benign acid compositions—citric acid, acetic acid and phosphoric acid—that effectively remove deposited dirt from engine components with little if any base metal attack. These solutions are non-fuming, have little if any exposure limits, possess broad composition windows for easy solution monitoring and in the case of citric and acetic acid can be disposed of through solution evaporation and burn-off. Also, phosphoric acid is both a cleaning composition and a stripping composition. Phosphoric acid can remove alumina-based TGOs and aluminide coatings down to base metal.

These and other features will become apparent from the following drawings and detailed discussion, which by way of example without limitation describe preferred embodiments of the present invention.

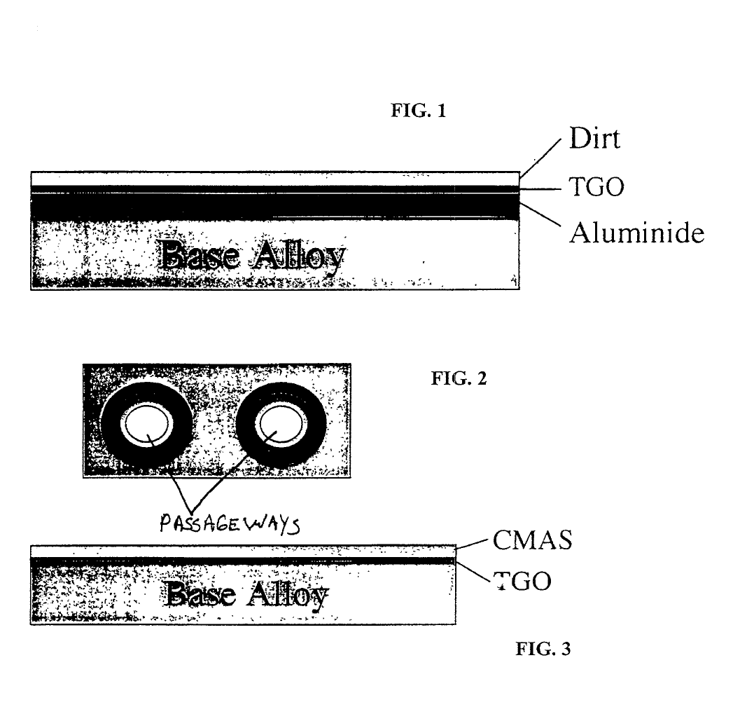

FIG. 1 is a schematic cross-sections of a turbine component alloy with a corrosion resistant aluminide coating with deposited dirt and thermally grown oxides (TGOs). FIG. 2 is a top view of the component, showing internal cooling passageways. Grit blasting techniques for cleaning the alloy are ineffective to clean the passageways. The compositions of the invention penetrate and clean these passageways. FIG. 3 is a schematic cross-sectional view of a CMAS coated Hast-X button used for screening and optimization of various chemical cleaning compositions. The CMAS simulates dirt found on real engine components. Measuring the mass of CMAS removed yields cleaning efficiency of a particular chemical cleaning system.

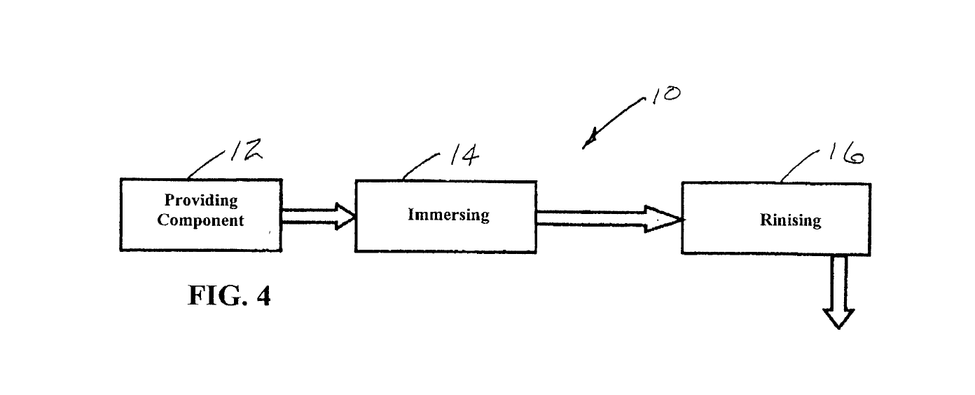

FIG. 4 is a schematic representation of the method 10 of the invention. Referring to FIG. 4, a dirtied engine component is provided 12, for example by removing a turbine engine from on-line duty and disassembling the engine into a component such as the nozzle. The component is immersed 14 in an acid solution for cleaning. The acid solution can be agitated during immersing for example by stirring or by the application of ultrasonics. The component is then rinsed 16, for example by immersion in deionized water. In one embodiment of the invention, ultrasonic agitation can be applied during the rinsing step16.

The following Examples are illustrative and should not be construed as a limitation on the scope of the claims unless a claim limitation is specifically recited.

### EXAMPLE 1

The Example demonstrates effective cleaning of airfoil surfaces without damaging underlying metal. A variety of chemical cleaning systems were evaluated for their dirt removal capability from stage 1 nozzles. The screening was conducted on control specimens consisting of 35 mil thick Ni-based Hast-X buttons coated with a plasma sprayed simulated dirt composition (oxides of Ca—Mg—Al—Si—(CMAS)). The CMAS coatings were amorphous as determined by x-ray diffraction analysis. The CMAS buttons were used to test a variety of process parameters, i.e., time, temperature and concentration. The chemical systems were also tested using scrap pieces of nozzles (PS) and blades (AE).

Solutions were prepared from reagent grade stock solutions mixed with house deionized (DI) water except for a Versene® solution (chelating and sequestering agent) and a Plurafac® surfactant.P (a polyoxyalkylene condensate). Cleaning procedures were carried out in glass beakers placed on magnetically stirred hot-plates. Temperature was controlled to within ±5° C. and was monitored by thermometers placed about ½ inch from the bottom of each glass beaker. CMAS buttons and scrap components were suspended in Al foil covered beakers in Monel® (nickel alloy) mesh baskets.

Cleaning efficiency of a chemical system was determined by measuring the mass of the CMAS coating before and after cleaning. The plasma spray process itself forms a thin TGO layer between the base alloy and CMAS (see schematic FIG. 3). The TGO layer affects weight loss measurement by about 5-10%.

A base alloy's resistance to chemical attack was determined from pieces of GTD-222 alloy, which were included during each screening experiment. These alloy pieces were mounted, polished and inspected optically for intergranular attack (IGA) and other indications of chemical reaction.

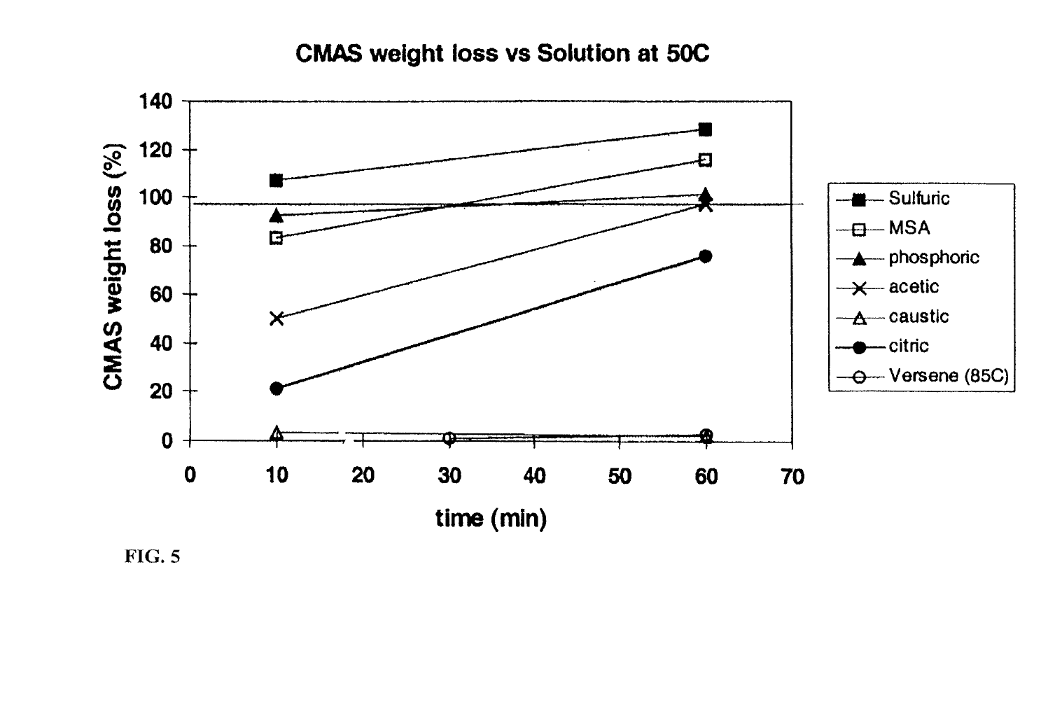

Cleaning efficiencies of 5M solutions of H₂SO₄, (38%). methanesulfonic acid (MSA) (45%), H₃PO₄ (40%), acetic acid (30%), NaOH (17%), citric acid (90%) and Versene® solution (40%) were measured at two temperatures (25° and 50° C.) and times (10 and 60 minutes). Results from a first series of chemicals tested for cleaning efficiency are listed in FIG. 5.

FIG. 5 shows percent weight loss of CMAS as a function of time (10 and 60 minutes) at 50° C. except for Versene® solution cleaning at 85° C. 100 percent weight loss indicates complete CMAS coating removal, while greater than 100 percent loss indicates base alloy attack.

Base alloy stability was determined by including pieces of GTD-222 buttons with each of the chemical cleaning runs. While none of the buttons exhibited detectable loss of mass, the piece included in the H₂SO₄ run (50° C., 60 minutes) exhibited grain etching. Cross sections of each of the GTD-222 pieces were polished and inspected by optical microscopy. No evidence of pitting, reaction or grain boundary attack was observed for any of the chemical cleaning systems. However, it was determined from the weight loss data of FIG. 5, that methanesulfonic acid (MSA) and sulfuric acid mildly attacked the HastX buttons.

The runs showed that the MSA and sulfuric acid were unsuitable because of base alloy attack. The NaOH and Versene® systems showed little or no CMAS coating removal. Even after 60 minutes at 50° C., less than 3% of the CMAS coating was removed by these systems. Acetic acid exhibited moderate cleaning ability comparable to citric acid. Phosphoric acid exhibited rapid cleaning without base metal attack, while citric acid cleaned at a moderate rate.

Several buttons exhibited a white residue after chemical cleaning. For a sulfuric acid cleaned button, the composition of the white residue was analyzed by x-ray diffraction to be mostly CaSO₄. The cleaning residue was completely removed by rinsing in an ultrasonic bath following chemical cleaning with magnetic stirring only.

### EXAMPLE 2

This Example illustrates effect of concentration, temperature and time with respect to citric acid cleaning efficiency.

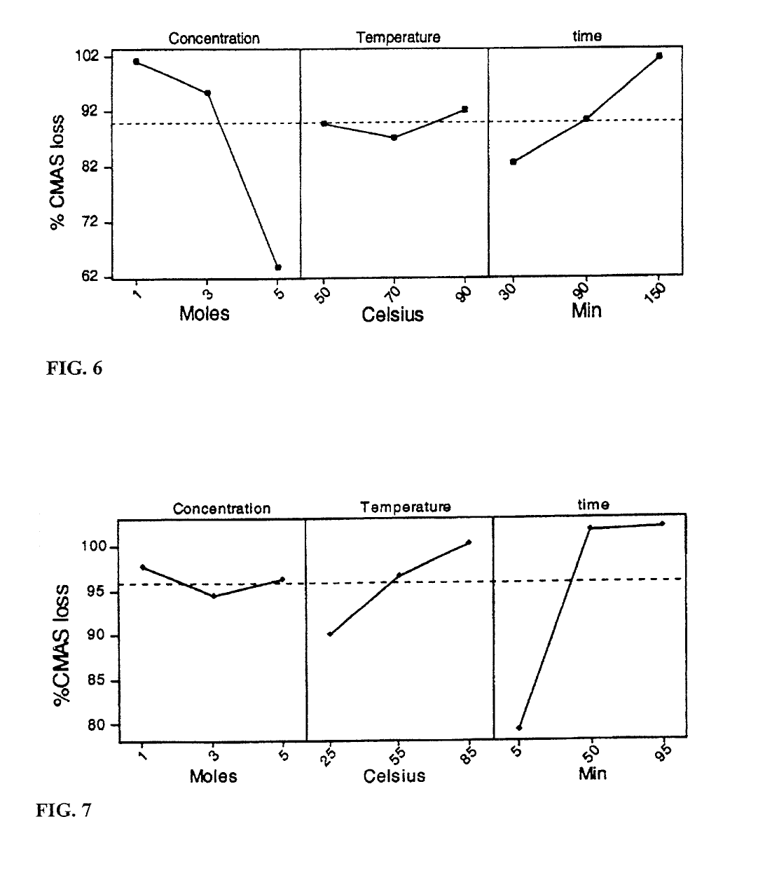

FIG. 6 is a resulting main effects plot determined by a Box-Benken design of experiment (DOE) for citric acid. FIG. 6 shows percent weight loss of CMAS for citric acid as a function of concentration, temperature and time (20%, 55%, 90% by weight solutions of monohydrous citric acid corresponds to IM, 3M & 5M solutions).

Cleaning efficiency with increased citric acid concentration was observed to decrease. While applicants should not be held to the following explanation, the decrease may be because there is not enough water available to fully dissociate citric acid at high concentrations. Another explanation may be that the viscosity of the solution increases with increasing citric acid concentration. The increased viscosity may cause difficulties in infiltrating the CMAS coating. Citric acid removed more of the CMAS coating with increasing soak time. Surprisingly, citric acid cleaning efficiency did not appear to vary for temperature between 50° C. and 90° C. This non-monotonic behavior can be taken as an upper limit to the inherent noise in the system, thus validating the dependence of citric acid's cleaning efficiency on concentration and time.

For citric acid, a broad temperature range can be about room temperature to about the solution boiling point, desirably about 40 to about 80° C. and preferably about 50 to about 70° C. Concentration can be about 0.1 to about 6 M, desirably about 1 to about 5 M and preferably about 2 to about 4 M. Contact time can be about 0.5 to about 48 hours, desirably about 1 to about 24 hours and preferably about 4 to about 8 hours.

### EXAMPLE 3

Concentration, temperature and time were similarly examined for a phosphoric acid cleaning system, However, different levels were used for temperature and time.

FIG. 7 is a resulting main effects plot for phosphoric acid. FIG. 7 shows percent weight loss of CMAS for phosphoric acid as a function of concentration, temperature and time (15%, 29% and 40% by weight of 85% H3P04 solution corresponds to 1M, 3M & 5M).

Cleaning efficiency of phosphoric acid exhibited little dependence on concentration from IM (15%) to 5M (40%). The cleaning efficiency of phosphoric acid increased with increasing temperature. Also, phosphoric acid removed more CMAS coating. The main effects plots indicates that cleaning nozzles with phosphoric acid does not require special care in controlling the concentration. The data show that chemical cleaning with phosphoric acid can be completed in short times and at relatively low temperature.

For phosphoric acid, a broad temperature range can be about room temperature to about the solution boiling point, desirably about 40 to about 80° C. and preferably about 50 to about 70° C. Concentration can be about 0.1 to about 8 M, desirably about 1 to about 7 M and preferably about 3 to about 5 M. Contact time can be about 0.5 to about 48 hours, desirably about 1 to about 24 hours and preferably about 4 to about 8 hours.

### EXAMPLE 4

This EXAMPLE illustrates cleaning of turbine engine components. Button sections of nozzle trailing edges were cleaned at 50° C. for 60 minutes in three acid solutions (citric, MSA, and phosphoric) along with corresponding CMAS control buttons. All three systems removed 100% of CMAS coatings on control buttons. After chemical cleaning, the nozzle sections weighed less and were visibly cleaner as indicated in the following TABLE 1.

TABLE 1

| Solution | Sample Type | CMAS/dirt removed |
|---|---|---|
| Ultrasonicate | button | 0 mg |
| in water | nozzle | 0 mg |
| 5M Citric | botton | 29.5 mg |
| (90%) | nozzle | 45.6 mg |
| MSA | button | 29.9 mg |
| (45%) | Nozzle | 54.1 mg |
| 5M H₃PO₄ | button | 29.9 mg |
| (40%) | nozzle | 39.2 mg |

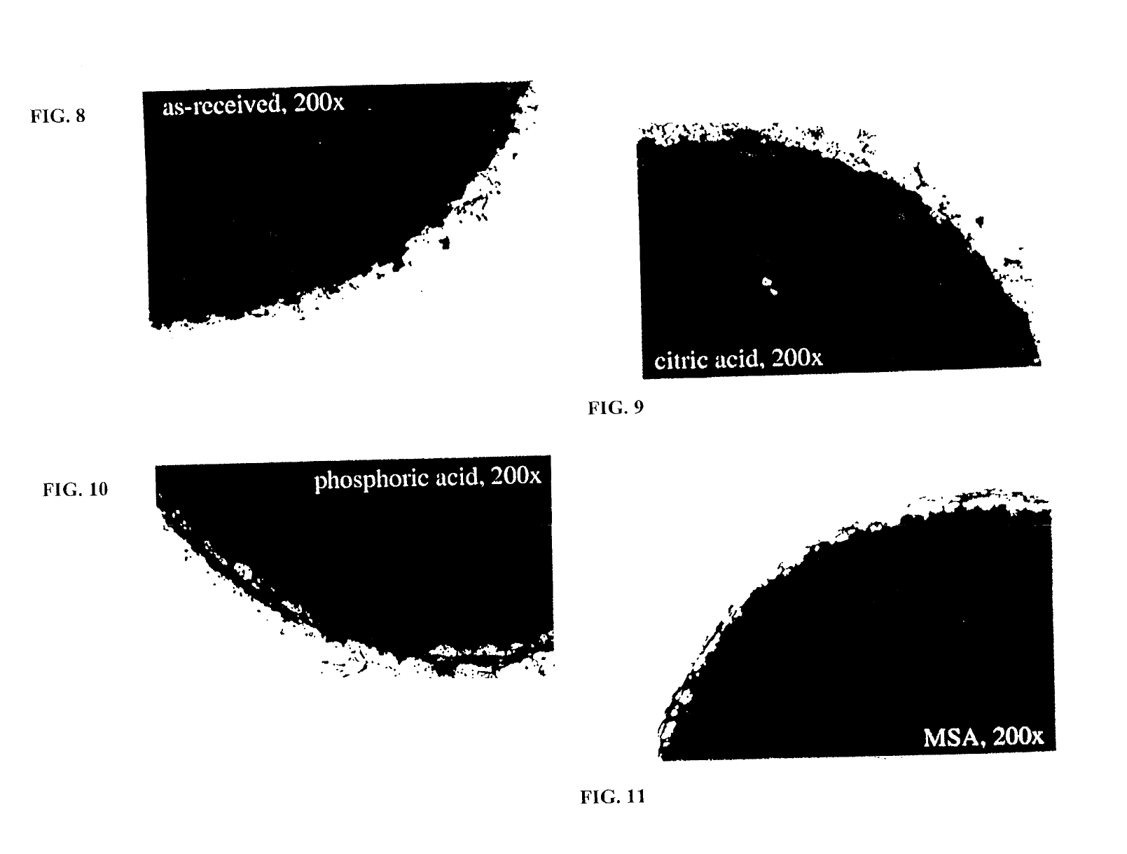

FIGS. 8, 9, 10 and 11 are optical micrographs of cross-sections of cooling holes on the trailing edges of nozzles for components cleaned in water (FIG. 8), citric acid (FIG. 9), phosphoric acid (FIG. 10) and MSA (FIG. 11). Citric acid, MSA and phosphoric acid removed material from both exterior surface and internal cooling holes. Phosphoric acid and MSA removed more dirt and thermally grown oxide from the cooling holes. The phosphoric acid, MSA and citric acid cleaned nozzle components revealed approximately equal weight loss. However, the phosphoric acid and MSA chemical components appeared cleaner particularly in the cooling holes.

### EXAMPLE 5

In this EXAMPLE, ultrasonics were applied to the cleaning solution during the cleaning step. These experiments were conducted by cleaning in acid filled beakers immersed in an ultrasonic bath. The temperature of the bath was maintained near 25° C. by periodic addition of ice chips.

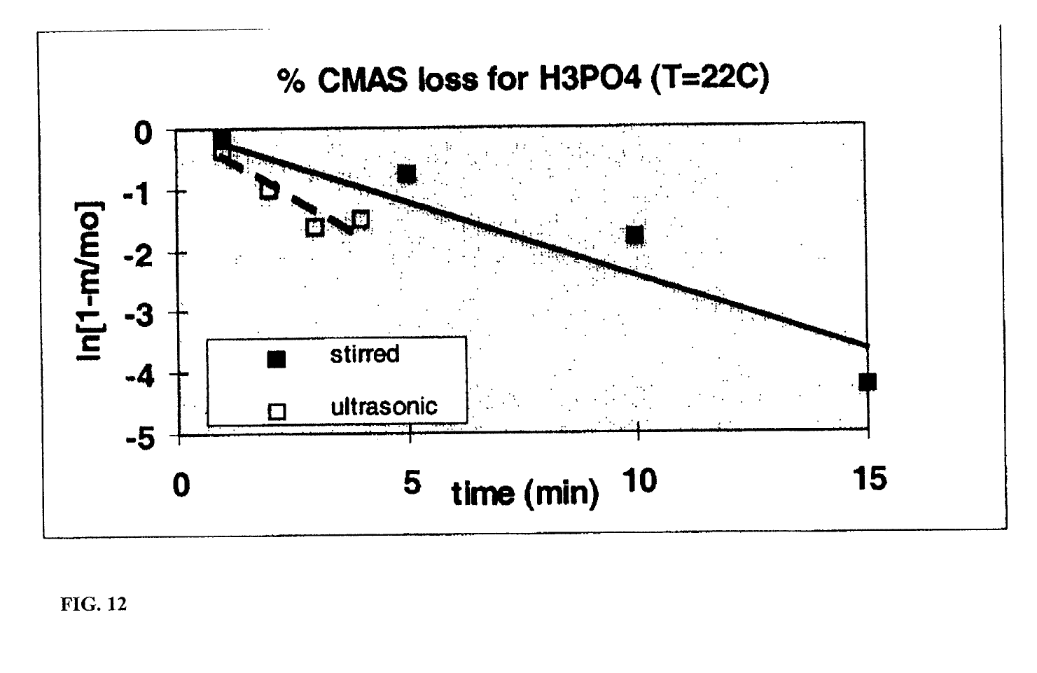

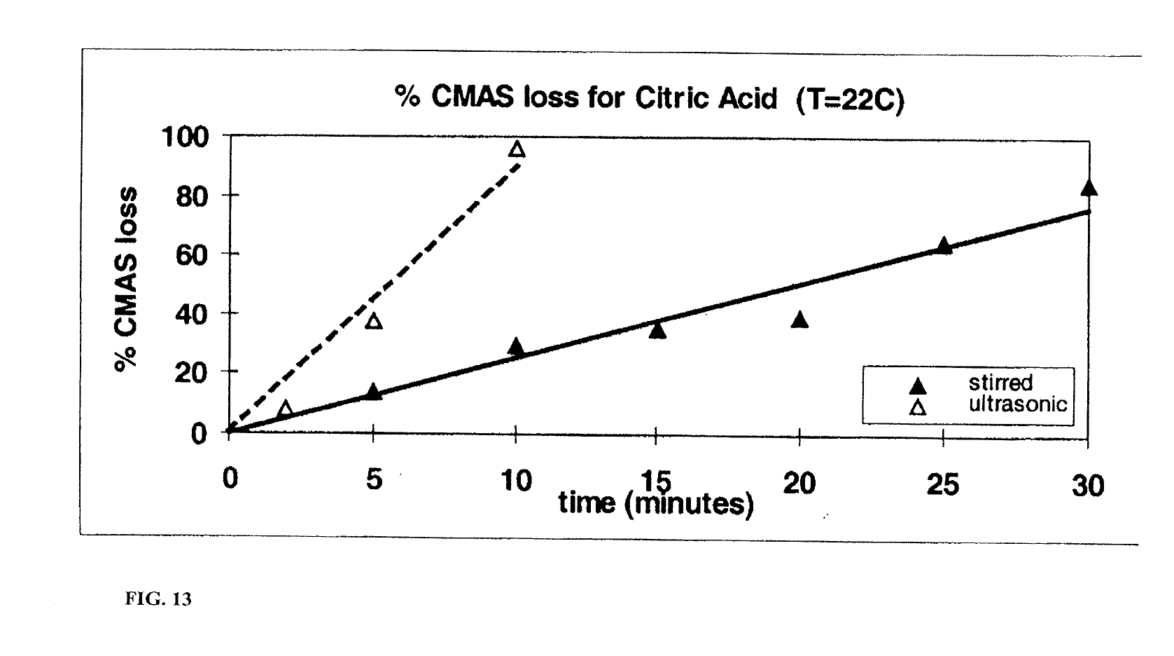

FIG. 12 and FIG. 13 show rate of CMAS coating loss as a function of either stirring or applying ultrasonics to a phosphoric acid or citric acid cleaning solution. Ultrasonics during the cleaning step removes the CMAS coating at a more rapid rate than simply immersing the button in a stirred solution.

The reaction rate for the phosphoric acid cleaning system follows a first order kinetic model according to Equation (1).

$$ln [ 1 - \frac{m}{{m}_{0}} ] = K ( t - {t}_{0} ) \qquad Equation ( 1 )$$

where m₀ is the starting mass of the CMAS coating, t₀ the starting time, m the mass of CMAS, which has reacted at time t, and K the reaction constant. The reaction constants K, for ultrasonic cleaning and cleaning in a stirred solution are respectively −0.44 and −0.24 sec⁻¹. Ultrasonic cleaning is almost a factor of two quicker than only stirring the phosphoric acid solution.

The reaction rate for the citric acid system follows zero-order kinetics typical of a surface reaction limited process according to Equation (2).

$$\frac{m}{{m}_{0}} = {K}^{′} ( t - {t}_{0} ) \qquad Equation ( 2 )$$

where K′ is different from the reaction constant in Equation (1). The reaction constants for citric acid for ultrasonic cleaning and stirred solution cleaning were 9.0 and 2.6 sec⁻¹, respectively. The constant for ultrasonic cleaning represents an almost four-fold increase in cleaning rate. Such an increase is unexpected in a surface reaction limited process.

The EXAMPLES show two chemical systems that can be used for cleaning optimization—an inorganic phosphoric acid, an organic citric acid and an organic acetic acid. Both phosphoric acid and citric acid systems readily removed CMAS coatings without visible base metal attack.

Acetic acid was also shown to be an effective chemical system for cleaning optimization. For acetic acid, a broad temperature range can be about room temperature to about the solution boiling point, desirably about 40 to about 80° C. and preferably about 50 to about 70° C. Concentration can be about 0.1 to about 8 M, desirably about 1 to about 7 M and preferably about 3 to about 5 M. Contact time can be about 0.5 to about 48 hours, desirably about 1 to about 24 hours and preferably about 4 to about 8 hours.

These systems are single component solutions that offer advantages in solution preparation, addition and process monitoring. The systems possess relatively broad processing windows, are environmentally acceptable and are readily available for industrial scale-up.

While preferred embodiments of the invention have been described, the present invention is capable of variation and modification and therefore should not be limited to the precise details of the EXAMPLES. The invention includes changes and alterations that fall within the purview of the following claims.

What is claimed is:

1. A method, comprising providing an engine component and immersing said component in an acid solution selected from phosphoric acid, citric acid and acetic acid.

2. The method of claim 1, wherein said acid solution comprises phosphoric acid.

3. The method of claim 1, wherein said acid solution comprises citric acid.

4. The method of claim 1, wherein said acid solution comprises acetic acid.

5. The method of claim 1, further comprising applying an agitation to said acid solution with immersed component.

6. The method of claim 1, further comprising applying an ultrasonic agitation to said acid solution with immersed component.

7. The method of claim 1, further comprising rinsing said component from said acid solution.

8. The method of claim 7, comprising rinsing in deionized water.

9. The method of claim 7, comprising applying an ultrasonic agitation during said rinsing.

10. The method of claim 1, comprising immersing said component in an about 0.1 to about 8 M phosphoric acid solution at a temperature from about room temperature to about the solution boiling point for a period from about 0.5 to about 48 hours.

11. The method of claim 1, comprising immersing said component in an about 1 to about 7 M phosphoric acid solution at a temperature from about 40 to about 80° C. for a period from about 1 to about 24 hours.

12. The method of claim 1, comprising immersing said component in an about 3 to about 5 M phosphoric acid solution at a temperature from about 50 to about 70° C. for a period from about 4 to about 8 hours.

13. The method of claim 1, comprising immersing said component in an about 0.1 to about 6 M citric acid solution at a temperature from about room temperature to about the solution boiling point for a period from about 0.5 to about 48 hours.

14. The method of claim 1, comprising immersing said component in an about 1 to about 5 M citric acid solution at a temperature from about 40 to about 80° C. for a period from about 1 to about 24 hours.

15. The method of claim 1, comprising immersing said component in an about 2 to about 4 M citric acid solution at a temperature from about 50 to about 70° C. for a period from about 4 to about 8 hours.

16. The method of claim 1, comprising immersing said component in an about 0.1 to about 8 M acetic acid solution at a temperature from about room temperature to about the solution boiling point for a period from about 0.5 to about 48 hours.

17. The method of claim 1, comprising immersing said component in an about 1 to about 7 M acetic acid solution at a temperature from about 40 to about 80° C. for a period from about 1 to about 24 hours.

18. The method of claim 1, comprising immersing said component in an about 3 to about 5 M acetic acid solution at a temperature from about 50 to about 70° C. for a period from about 4 to about 8 hours.

19. The method of claim 1, wherein said acid solution is phosphoric acid and said reaction proceeds according to a Kinetic model represented by formula (1),
$$ln [ 1 - \frac{m}{{m}_{0}} ] = K ( t - {t}_{0} )$$
where m₀ is a starting mass of a dirt coating, t₀ is a cleaning starting time, m is a mass of dirt coating, which has reacted at time t, and K is a reaction constant.

20. The method of claim 1, wherein said acid solution is citric acid and said reaction proceeds according to a Kinetic model represented by formula (2),
$$\frac{m}{{m}_{0}} = {K}^{′} ( t - {t}_{0} )$$
where m₀ is a starting mass of a dirt coating, t₀ is a cleaning starting time, m is a mass of dirt coating, which has reacted at time t, and K is a reaction constant.

21. A cleaning composition for an engine component, comprising an ultrasonic agitated acid solution selected from phosphoric acid, citric acid and acetic acid.

22. The composition of claim 21, further comprising an engine component immersed in said agitated acid solution.

23. The composition of claim 21, comprising an about 0.1 to about 8 M phosphoric acid solution.

24. The composition of claim 21, comprising an about 1 to about 7 M phosphoric acid solution.

25. The composition of claim 21, comprising an about 3 to about 5 M phosphoric acid solution.

26. The composition of claim 21, comprising an about 0.1 to about 6 M citric acid solution.

27. The composition of claim 21, comprising an about 1 to about 5 M citric acid solution.

28. The composition of claim 21, comprising an about 2 to about 4 M citric acid solution.

29. The composition of claim 21, comprising an about 0.1 to about 8 M acetic acid solution.

30. The composition of claim 21, comprising an about 1 to about 7 M acetic acid solution.

31. The composition of claim 21, comprising an about 3 to about 5 M acetic acid solution.
